(19) United States
(12) Patent Application Publication
(10) Pub. No.: US 2005/0111662 A1
(43) Pub. Date: May 26, 2005

(54) Method for internet distribution of music and other streaming media

(75) Inventor: Mark Geoffrey Fiedler, New York, NY (US)

Correspondence Address: Mark Fiedler;Recent Memory Incorporated, Apt. 6JE, 160 Bleecker Street, New York, NY, 10012-1420, US

(73) Assignee: Recent Memory Incorporated

(21) Appl. No.: 10/956,922

(22) Filed: Sep. 30, 2004

Related U.S. Application Data
(63) Continuation-in-part of application No. 10/632,775, filed on Aug. 1, 2003.
Application No. 10/632,775 is a division of application No. 09/884,532, filed on Jun. 20, 2001, now Pat. No. 6,804,638.
(60) Provisional application No. 60/508,338, filed on Oct. 3, 2003.

(51) Int. Cl. H04N 7/167

(52) U.S. Cl. 380/201

(57) ABSTRACT

A method of promoting and distributing music and similar streaming content on the Internet or a similar network, combining the secure submission of streaming content by its originators to a plurality of potential webcasters; the selection and webcasting of such submitted content by webcasters; the downloading of selections from webcasts by listeners; and the collection and distribution of fees from such downloads, all using software made freely available for download from the network.

This is the non-provisional counterpart of U.S. Provisional Patent Application Ser. No. 60/508,338 (Netcast Buffering Method), filed Oct. 3, 2003. This is also a continuation in part of U.S. patent application Ser. No. 10/632,775, filed Aug. 1, 2003, entitled “Device and Method for Selective Recall and Preservation of Events Prior to Decision to Record the Events,” which is in turn a division of U.S. patent application Ser. No. 09/884,532, filed Jun. 20, 2001, also entitled “Device and Method for Selective Recall and Preservation of Events Prior to Decision to Record the Events,” which is the non-provisional counterpart of Ser. No. 60/133,801 (Applications and Improvements for Selective Recording Method), filed May 11, 1999.

### FIELD OF THE INVENTION

This invention relates to the promotion, transmission and distribution of streaming content to a population of potential customers over a network, and particularly to the promotion, transmission and distribution of digital music over the Internet.

### BACKGROUND OF THE INVENTION

The Internet is a comparatively novel forum for the distribution of music. Up to now the bulk of all sales (as distinct from free distributions) of recorded music to consumers have been made by record stores (both online and off-), who are in turn supplied by a mature, relatively closed production and distribution industry comprising a handful of large record companies (known popularly as “labels”) and numerous smaller “independent labels.” Barriers to entry into this industry have been as high for recording artists as they have been for new production and distribution companies. To have their work distributed, artists must negotiate (in common parlance, “sign”) a recording contract with one of these companies, an arrangement offered to only a comparatively small number of artists. Moreover, such contracts are generally not favorable to recording artists: not only do they usually transfer the artist's copyright and control of the music to the label; they also generally provide for payment of royalties to the artist only after deducting a variety of expenses, all incurred at the label's discretion, which comprise virtually all costs of promotion, production and distribution.

The Internet has dramatically expanded the possibilities for recording artists to reach the public, by both lowering the cost of entry and expanding the number of channels available. In the past few years there has been a veritable explosion of music on the Internet. The vast majority of this music is made available to the public through two distinct kinds of Internet entities: (1) Internet radio stations, which, on a user's request, broadcast a continuous stream of content (without giving users the ability to download content into files) and (2) music sites that list discrete files of content that listeners may sample, play and/or download at their will.

A number of both kinds of sites charge for their services, on a subscription or a per-download basis. Of these, only those that list music titles for downloading at a price can be of any direct monetary benefit to recording artists. This arrangement works best for distributing the music of “signed” artists who possess the advantage of being known to a sufficient audience. Lesser-known artists are at a significant disadvantage in this arena because, to put it simply, people download what they know. Aside from rare and random combinations of chance and human curiosity, a person browsing the Internet generally finds him- or herself at a music website as a result of having been directed there. If it is a band's website, this is usually a result of the band's level of promotion. If it is a music website that lists many selections for download, a potential customer has to believe that a selection is worth the time and effort of downloading. This too is generally the result of promotion-generated awareness, which will be much greater in the case of artists signed with major labels than with unsigned ones.

From the point of view of recording artists and other producers of music wishing to reach the public, websites that broadcast a continuous stream have a decided advantage over those that list titles for playing or downloading: No action is required of a listener to hear any particular content, other than “tuning in” to the broadcast at the right time. Especially with new and unfamiliar content, listeners may not know they want to listen to something until they hear it, and broadcasting a continuous stream of content assures that they will.

However, current continuous-stream audio broadcasting technology does not allow users to download and store segments of music or other content directly from the stream. The major technical obstacle to doing so is this: By the time a listener has heard or viewed enough of a selection to decide to download it, at least some of that selection has already been played; the listener would need to be able to “go back” somehow in order to record the entire selection. Accordingly, there is a need for a means of doing so, which is an object of the present invention. (As detailed below, the present invention solves this problem by maintaining a buffer on the listener's computer that always contains a certain length of the most recently broadcast material, including all of the selection currently being played.)

The ability to download segments from a continuous broadcast stream opens the possibility of enforcing payment for such downloads. The combination of these technologies, using encryption and other security methods, has a clear advantage over the current method of listing files for download.

Websites that list music titles for downloading include listings of new and unknown music. These are good for those that happen to be displayed near the top of a list, and of much less benefit for those farther down. To overcome this, artists have tried to put attractive searchable keywords in their song titles, but that is of understandably limited utility.

Recording artists (and similar originators of streaming content) need, and it is an object of the present invention to provide them with, access to a large number of potential outlets for their work to be consumed and paid for; and, conversely to provide webcasters with a large number of sources of content for webcasts.

### SUMMARY OF THE INVENTION

Historically, radio airplay has been the primary means of promoting new music, and streaming audio play on the Internet can clearly serve the same role. It is advantageous for such streaming audio play to be as accessible to the public, free of charge, as radio has historically been. By combining streaming audio with the ability to instantly download segments of it, the new technology may serve not only as an essential promotion vehicle for relatively unknown artists, but also as an optimally placed sales vehicle. Listeners will be able to sample the flavor of a station's mix simply by “tuning into” the station. If they like what they hear, they will stay tuned, even while visually browsing other sites. It will cost them nothing, not even a click, to hear the music. And, of course, they will have the ability to download whatever they hear for a modest fee.

In light of the veritable explosion of music made available on the Internet, it has been pointed out that the established record companies (as well as the traditional radio stations that play their music) do perform an essential function: By serving only a small number of artists, they serve to filter the vast quantities of recorded music for certain standards of quality and taste with regard to any particular genre. The present invention brings this ability onto the web in a novel form, employing great numbers of voluntary participants. This phenomenon is expected to emerge as follows: As webcasters' stations proliferate, each station comes under a certain pressure to distinguish itself with its own unique “flavor” that listeners should come to identify with that station. The “mix” of a station—not just the selection of music, but the particular sequence in which it is presented—is a significant force in attracting and retaining listeners. It is particularly effective in getting them to listen to new music, much more so than merely listing music titles for downloading. And recording artists will be motivated to place their work with those broadcasters in whom they perceive an affinity—in the expectation of having it heard and collecting fees from listeners' downloads.

This technology works well for music that is relatively unknown—music that listeners will generally be hearing for the first time. The promise of public exposure and possibility of getting paid for downloads will encourage lesser-known artists to place their music with participating webcasters. Likewise, the promise of a free supply of creative content—along with the possibility of being paid for downloads, in contrast to the certainty of incurring liability for webcast royalties that currently obtains for webcasting music from the established record companies' catalogs—will encourage individuals and organizations to participate as webcasters.

### BRIEF DESCRIPTION OF DRAWINGS

FIG. 1 shows an overall block diagram of the parts of the preferred embodiment and their interrelationships.

FIG. 2 shows interactions between the artist and webcaster modules.

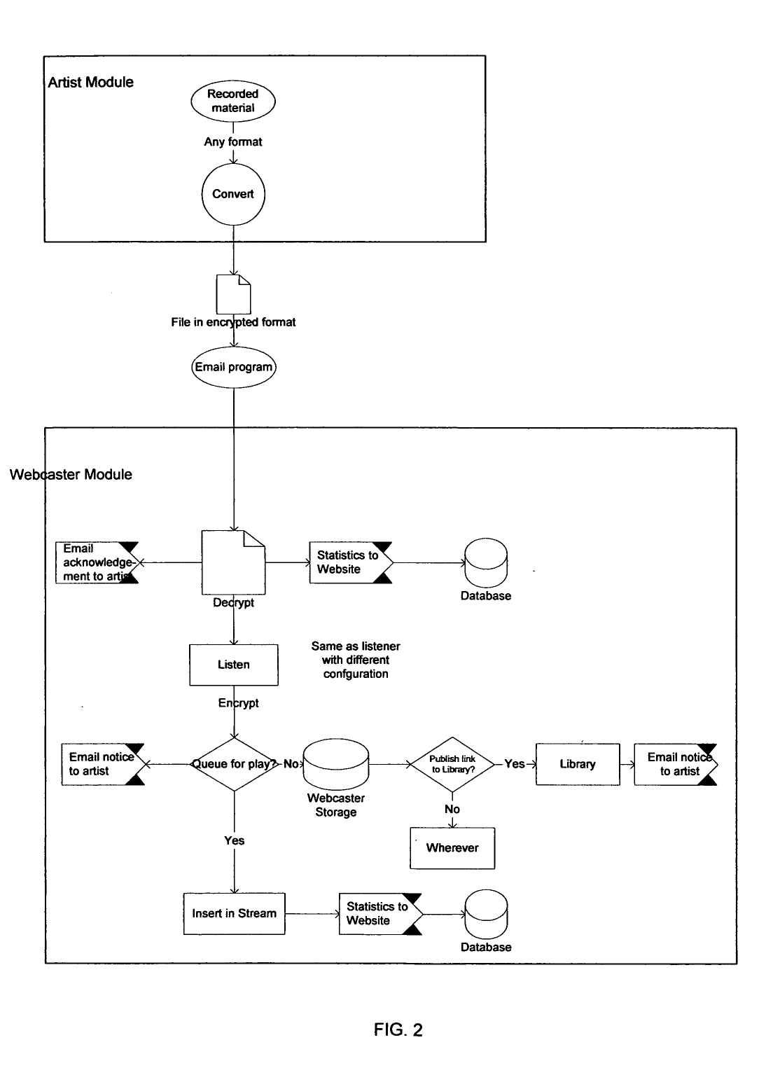

### DETAILED DESCRIPTION OF THE PREFERRED EMBODIMENT

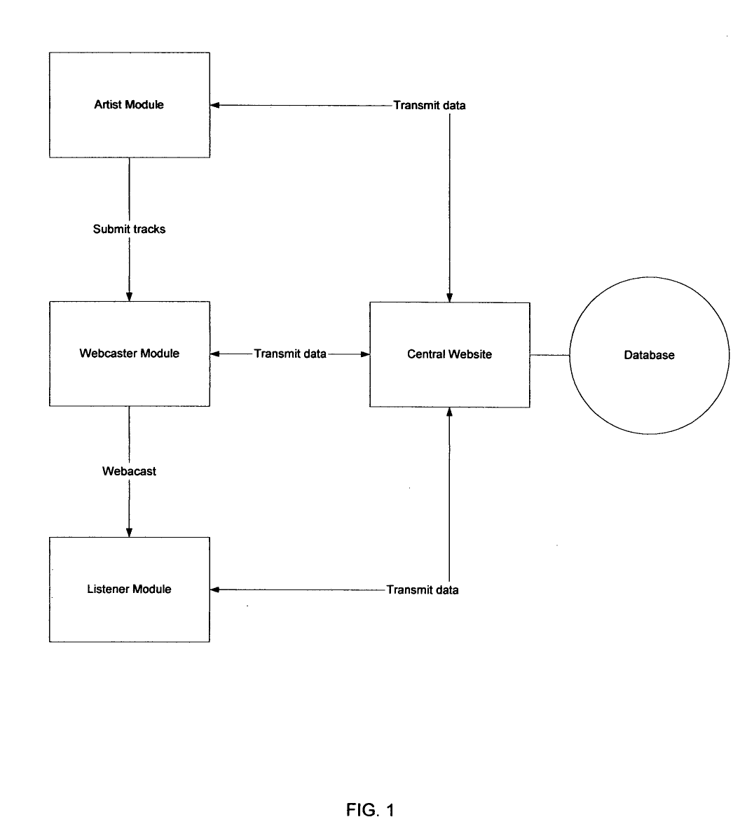

FIG. 1 shows the major components and their interrelationships:
(1) An artist module that enables a recording artist (or similar originator of digital streaming content) to (a) encrypt streaming files, tagging them with information identifying the the artist, composer musicians and the like as well as title information, and (b) submit them to webcasters, advantageously via electronic mail.
(2) A webcaster module that enables a webcaster to (a) receive and review (i.e., listen to) encrypted streaming files submitted by artists, (b) select which of these files to include in webcasts, (c) arrange them into playlists to be webcast, and (d) webcast these playlists.
(3) A listener module that enables a listener to select a webcast, listen to the webcast and select discrete portions of the webcast (generally corresponding to discrete content files) for download. This module advantageously incorporates a circular buffer which accumulates the most recent set of content streamed, advantageously in encrypted form.
(4) A central web site comprising a database identifying all artists and webcasters and web pages providing, among other things, the ability to search for webcasters and streaming content, advantageously by genre. All users—artists, webcasters and listeners—will advantageously use these pages to compile lists of artists, webcasters and the like. The central web site also advantageously comprises facilities for registering new artists and webcasters, downloading their respective software modules, and providing authentication means for submissions and purchases of streaming content.

These components (and their human users) will interact as follows:
(1) An Internet radio/television station (“webcaster”) will provide a continuous stream of music, video or other content (“webcast”) to listeners. This content stream will be temporarily stored in a circular buffer (“acquisition buffer”) in the listener's computer or Internet appliance, or otherwise under the control of the listener. The acquisition buffer will accumulate the webcast stream, overwriting the oldest material with current material so that it contains, at any given time, the most recently received material. Listeners (as used herein, the term includes viewers) will be able to permanently save (“download”) portions of the content stream from this acquisition buffer to permanent storage. This arrangement will allow relatively low-powered servers to be used for webcasting the stream of content, as they will be largely freed from the task of re-transmitting the portions of the stream which listeners decide to download—a task that may be precluded at any given time by having all available bandwidth occupied by connected listeners. Individuals and organizations of all sizes and means will be enabled to engage in this manner of webcasting by means of webcasting software supplied for free (or at a nominal charge) over the Internet. This will transmit a continuous stream of content to a corresponding client application, similarly provided for free (or low-cost) Internet download.
(2) Recording artists, copyright holders or similar parties (“originators”) will be able to submit pieces of their work to webcasters at no charge or at a nominal charge. This submission is advantageously done over the Internet in a secure form, using a software tool designed for the purpose. The submitted work advantageously incorporates the originator's bid for a proposed royalty arrangement for the work, which may be encoded using a dedicated software tool. Security in this regard may take a number of forms: In one arrangement, the work may be played by the webcaster but not webcast until enabled by the originator. In another, the originator's proposed royalty arrangement will be securely implemented and enforced when the work is webcast and downloaded, but the webcaster may refuse to webcast the work under those terms. In both of these cases, the webcaster will be enabled to webcast the work in question when both the originator and the webcaster agree on a royalty arrangement. The negotiation software will facilitate the process of coming to such an agreement, and the webcasting software will enforce the agreed terms. The overall fee scheme may incorporate fees (advantageously at a fixed rate, independent of those due webcasters and originators) due to the holder (or a licensee) of this patent, as well those due copyright holders not participating in the system.
(3) Webcasters will typically produce sequences (“mixes”) of the works or one or more originators, advantageously in an interesting, entertaining or artistic sequence. These mixes will be webcast by each originator on one or more channels, advantageously using the dedicated software provided as a free or low-cost download over the Internet. Each webcaster will advantageously cultivate a reputation or “presence” among the listening public as well as the population of originators, who will be drawn to particular webcasters and their webcast channels on the basis of such reputation. A central Web site will advantageously be maintained by the holder of this patent or a licensee, providing information on the webcasters and the content they provide, advantageously including affinities between webcasters, their genres of content, and the like.
(4) It is advantageous to enable webcasters to place any track submitted to them in an accessible storage area (“library”) under the webcaster's control, from which the track will be made available to other webcasters, and possibly for paid download by listeners.
(5) It is advantageous to generate the following automatic notifications, by electronic mail or message between the various modules of the system:
   a. to an artist (as well as the central website) upon acceptance of a track by a webcaster,
   b. to the central website upon the initiation of a webcast;
   c. to the artist upon a webcaster's selection of a track for inclusion in a library.
It is also advantageous to provide artists and webcasters, at their request, with statistics from the database pertaining to the content they have have originated and/or webcast.
(6) As some webcasters may receive more submission than they are willing or able to handle, it is advantageous to enable a webcaster to designate a party (“broker”) to receive submissions from artists. Those selections accepted by the broker will be automatically forwarded to the artists. The webcaster's income from downloads of tracks submitted by a particular broker may be advantageously shared with the br(1 oker, advantageously using automated means. The negotiation apparatus described above, or the like, may be advantageously used to arrange such sharing of income.
(7) To augment the number of listeners that may be simultaneously connected to a webcasting server (which may have no more webcasting bandwidth than a low-end personal computer on a home Internet connection), the server may webcast a continuous stream of content to an acquisition buffer on a supplemental server, advantageously with much greater bandwidth, which in turn webcasts the stream to listeners from its acquisition buffer. This second, supplemental server may also webcast to a third server, and so forth. (Any server in the scheme may, of course, advantageously webcast directly to listeners as well to another server.) The scheme may be extended indefinitely, with each successive supplemental server invoked on demand by another server in the sequence. The use of an acquisition buffer on a sufficiently capable supplemental server may obviate the need for an acquisition buffer on a listener's client machine, as the supplemental server may re-transmit data that still remains in its acquisition buffer on demand from a client machine. Like webcasting servers, supplemental servers may be operated by arbitrary parties, who may expect payment for their operation. Such payment may be according to a server's operating time and/or an apportioned share of revenue from actual downloads. The negotiation and collection of such payments may advantageously be handled in the same manner as those due originators and webcasters, described below. It is worth noting that a listener's computer or Internet appliance may serve as a supplemental server, re-transmitting the stream of content to other listeners; and that this may entitle such a listener to credits, fees or other similar compensation, which may be derived from the webcaster's fees. Further, a particular finite webcast stream may be initially loaded from an originator's location to a supplemental server and subsequently re-webcast, perhaps repeatedly, by one or more supplemental servers, thus freeing the originator's machine from the task of webcasting the stream in real time.
(8) An appropriate client application, running on a computer or on an appropriate internet appliance at the listener's location, will advantageously list all selections of music or other content currently contained in the circular buffer (and, advantageously, selections preceding and following these as well). A mark identifying each downloadable selection is advantageously placed in the webcast stream at the beginning of each selection. The location of each such mark contained in the circular buffer is maintained in the client application in association with information identifying and/or describing the selections available to be downloaded. Listeners may decide to download selections that have not yet been transmitted, in which case the client application will download these when they are transmitted, and on payment of any required fees. Selections lying wholly or partly outside the buffer may be downloaded by specific request to a server. In this connection, it is advantageous to maintain a circular buffer on a server to respond to such requests.
(9) The client application will allow listeners to listen to webcasts without requiring any payment, logging—in or registration of their identity, by connecting to (or “tuning into”) a station or ordering a finite “mix” or concatenation of works assembled by or for a webcaster. Listeners will pay to download webcast content into files (or similar permanent, possibly reproducible units) on their local workstations or otherwise in their possession or under their control. Originators (and possibly other parties such as webcasters and supplemental server operators) will collect royalties and/or other fees on their work from end users (or intermediate users) of their work from these payments. A number of payment arrangements are possible: In addition to single payments at the time of downloading, subscription arrangements may allow a predetermined number of downloads within a predetermined period of time (with or without the possibility of refunds or rebates for unused opportunities).
(10) Royalties and/or other fees may be shared with the Internet radio station and/or other parties as may be agreed between the parties concerned. Such agreement may be advantageously negotiated via the Internet, using a dedicated software tool or tools. Payments are advantageously collected using well-known “e-commerce” programs, particularly “micropayment” systems. Such programs advantageously incorporate secure storage of credit card data protected by a password for each individual user, as well as means for securing payment to the appropriate parties with regard to each webcaster.
(11) The central website, by communicating with browser and client applications, enables users to search for both music and webcasters, advantageously on the basis of identified genre tags. Each music track will be advantageously tagged with one or more genre tags, and the set of genre tags is expected to evolve over time.
(12) The central website is notified of the initiation of any webcast and supplied the contents of its playlist, which are in turn stored in the database. This enables listeners to search the database for a particular music track (or similar content file) that is currently or soon to be webcast, and to connect to the webcast that contains it.
   Encryption

The various parties involved in these transactions will generally be unknown to each other, and generally not in a position to be trusted by the other parties involved. To enforce the payment of royalties and other fees to the proper parties, the internet radio stream is advantageously transmitted (in all phases of submission and distribution) in encrypted form, which is ultimately decrypted as it is played by the various receiving applications. Acquisition buffers are advantageously used as decryption buffers, in addition to their functions in connection with downloading and ensuring continuous playing of the content stream.

The encryption/decryption scheme may advantageously incorporate the following refinements:
(1) Encryption/decryption keys may be embedded in the transmission data stream at periodic intervals (or at fixed or varying intervals determined by a predetermined scheme); each key will govern the decryption of data following the key and preceding the next key, and provision will be made for a newly connecting user's client application to acquire the current key as well as the location of the next key.
(2) Encryption/decryption keys may be assembled from segments supplied by disparate components of the system involved in a webcast. For example, the key used for encrypting and decrypting the contents of a listener's circular buffer may be assembled from components supplied by the webcaster module, the listener module and/or the central database. Further, these segments may be assembled into the key in a secret, non-straightforward manner.
(3) Sections downloaded by a user may themselves be encrypted, but decryptable by a user supplying a password. Not only does this arrangement limit the free copying of downloaded selections; it also allows the collection of royalties for repeated playings of the selection.
(4) Any such restrictions or fees imposed on copying or playing downloaded selections may be proposed by the originator and/or agreed to by the webcaster and will be indicated to the listener together with any other terms of downloading the selection.
   Non-Participating Content; Anti-Fraud

Current U.S. law mandates the payment of specified royalties for webcasting copyrighted content in the absence of any contractual arrangement between webcasters and copyright holders. Artists participating in the present invention will waive all such webcasting royalties in favor of payment for downloads by listeners, and will certify (by generally accepted mechanized means, as by checking a box on the screen) their valid rights to any music files they submit to webcasters. On the other hand, webcasting royalties must be paid on streaming content from non-participating sources, and such content must not be made available for downloading by listeners. Accordingly, it is necessary to deter and detect fraudulent claims of rights by those submitting content for webcasting with the ability to download—typically cases of originators passing off other people's work as their own. Towards this end, it is advantageous not only to encrypt the originating artist's identity into all content files submitted by the artist, but to preserve a recoverable, encrypted steganographic record identifying the originating artist identity in all tracks downloaded by listeners. It is also advantageous to encourage all participants-artists, webcasters and listeners—to detect and report cases of fraud, and to establish a forum for adjudicating claims of fraud, with appropriate penalties both for fraud and for intentionally fraudulent claims of fraud.

Webcasting of content from non-participating sources may be advantageously effected as follows: All webcasters (as well as all artists) will have accounts from which funds due them from listeners' downloads will be distributed periodically. The system will advantageously allow the webcasting content from non-participating sources only to the extent that the webcaster's account is credited with sufficient funds to cover the requisite webcast royalties; otherwise the system (i.e., the webcast module) will automatically omit such content from webcasts—advantageously with notice to the webcaster.

Webcast Buffering

A further advantageous refinement of this general method may be explained as follows:

Consider that a webcast stream typically consists of a series of segments or “tracks,” which typically correspond to musical selections, movements, or pieces; and the prior method enables listeners to purchase individual tracks. When a listener first connects with (or “tunes into”) a specific webcast, it will almost always be in the middle of a track. A listener will typically decide to stay connected (or “tuned”) to a specific webcast on the basis of liking this first, usually fragmentary track, and will likely be inclined to purchase this track. Should the user decide to purchase the track, it will be advantageous (nay, only decent) to provide the listener with the whole track. The method described thus far provides for supplying the listener with the missing portion by a specific request to the server—but this cannot be relied on, particularly if the server is connected to its maximum number of clients (i.e., listeners). Moreover, the fact remains that the listener has not heard the whole first track (more particularly the first part of it), and might have been inclined to purchase it had he or she heard it.

Accordingly, it is advantageous to ensure that the first track a listener hears upon connecting to a webcast will be presented, locally buffered, and offered for purchase in its entirety—or at least from the beginning.

This may be achieved as follows: A webcast server application typically receives input from a single stream of digital content (in this case, typically music) which is segmented into individual tracks that are demarcated by marks or other indications embedded in or referring to the stream. (Webcast servers may in fact handle multiple input streams, in which case the method described below is applied to each input stream.) The webcast server translates this input stream into multiple Internet-protocol packet streams, one directed to each listener that is connected to the webcast. To ensure that each listener hears the beginning of a track on connecting with the server:
(1) When the webcast server application encounters the beginning of a track, it begins writing a buffer (in memory, on a disk or similar storage device, or in any combination thereof) (a “track buffer”) which will be used to generate the individual packet streams. This buffer grows in size until it contains the entire contents of the track.
(2) As each listener connects with the webcast, the server application begins generating packet streams directed to that listener from the beginning of the track it is currently receiving from a streaming source. Thus each listener hears the current track from the beginning.
(3) A track buffer is maintained until all connected client applications have received its entire contents. At that point it clears, frees, or simply starts overwriting any existing track buffer.
(4) The maximum size of a track buffer may be advantageously set by the server application user. It is also advantageous (alternatively) to check the webcasters hard disk and/or memory capacity for sufficient space for any two successive tracks in the webcast, and (advantageously with notice to the webcaster) to automatically omit from the webcast any track that won't fit.

This method may be similarly applied to any supplemental server as described above.

Although the present invention has been described in connection with particular applications thereof, it is to be understood that additional embodiments, applications, and modifications, which will be obvious to those skilled in the art, included in the spirit and scope of the invention.

In the following claims:

The word “media” includes, without limitation, music, speech, moving pictures, sequences of still pictures, speech, any and all auditory or visual events, data or signals, still or moving pictures, machine events, states or signals, and the states, signals or sounds of any musical instrument, any of the foregoing being of a discrete or a continuous nature.

While the preferred embodiment of the invention has been described in detail, modifications and adaptations may be made thereto, without departing from the spirit and scope of the invention, as delineated in the following claims:

1. A broadcasting method combining the steps of:
providing a computer program (“webcast server”) that enables a user (“streamer”) to transmit (“stream”) a stream of media (“content”) comprising a sequence of discrete segments (“tracks”) to one or more client applications,
writing, using the streaming software, a buffer (“track buffer”) which at any given time contains the entire portion of the track currently being streamed which has already been streamed, and,
as each said client application connects with said webcast sever, sequentially transmitting the contents of said track buffer from the beginning, thus ensuring that said client application receives entire tracks.
